(19) United States
(12) Patent Application Publication
(10) Pub. No.: US 2014/0288985 A1
(43) Pub. Date: Sep. 25, 2014

(54) COMPUTER IMPLEMENTED METHODS AND APPARATUS FOR MANAGING OBJECTIVES ASSOCIATED WITH AN ORGANIZATION

(71) Applicant: salesforce.com, inc., San Francisco, CA (US)

(72) Inventors: Daniel Debow, Toronto (CA); Maksim Ovsyannikov, San Francisco, CA (US); Woodson Jackson Martin, Atherton, CA (US); Austin Tam, Toronto (CA); Ryan Allan Dewsbury, Toronto (CA); Alan O'Conner, San Francisco, CA (US); Marcus Gosling, Woodside, CA (US); Qinghua Yang Qinghua Yang, Toronto (CA); Nathan Bradshaw, Pickering (CA); Margaret Cryzan, Toronto (CA); Renato Bellia, Toronto (CA); James Fai-Kuen Tam, Toronto (CA); Alex Ovesea, Woodbridge (VA); Iurie Cangea, Ajax (CA); Tihomir Bajic, San Francisco, CA (US); Jager McConnell, San Francisco, CA (US); Ciara Peter, San Francisco, CA (US)

(21) Appl. No.: 14/294,441

(22) Filed: Jun. 3, 2014

Related U.S. Application Data
(63) Continuation-in-part of application No. 14/026,859, filed on Sep. 13, 2013.
(60) Provisional application No. 61/701,281, filed on Sep. 14, 2012.
(60) Provisional application No. 61/847,375, filed on Jul. 17, 2013.
(60) Provisional application No. 61/847,381, filed on Jul. 17, 2013.

(51) Int. Cl. G06Q 10/06

(52) U.S. Cl. CPC G06Q 10/063114
USPC 705/7.15

(57) ABSTRACT

Disclosed are methods, apparatus, systems, and computer readable storage media for managing objectives in an organization. A server may receive an objective at a first level of an objective hierarchy. The objective may be associated with a completion indicator providing progress towards completing the objective. Other objectives at a lower level of the objective hierarchy may be determined. The other objectives may also include completion indicators. The progress of the completion indicator of the objective at the first level of the objective hierarchy may be based on the completion indicators of the objectives at the lower level of the objective hierarchy.

### PRIORITY DATA

This patent document claims priority to co-pending and commonly assigned U.S. Provisional Patent Application No. 61/847,381, titled “Systems and Methods for Creating a Goals Hierarchy in a Multi-Tenant Organization,” by McConnell, et al., filed on Jul. 17, 2013, U.S. Provisional Patent Application No. 61/847,375, titled “Systems and Methods for Creating Dynamic Goals in an Online Social Environment,” by McConnell, et al., filed on Jul. 17, 2013, and is a continuation-in-part of U.S. patent application Ser. No. 14/026,859, titled “Computer Implemented Methods and Apparatus for Managing Objectives in an Organization in a Social Network Environment,” by Gosling, et al., filed on Sep. 13, 2013, which claims priority to U.S. Provisional Patent Application No. 61/701,281, titled “System and Method for Managing Resources in a Social Network Environment”, by Gosling, et al., filed on Sep. 14, 2012, all of which are hereby incorporated by reference in their entirety and for all purposes.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This patent document relates generally to managing objectives related to an organization using different types of database records, and more specifically, to providing a hierarchy of objectives in the organization.

### BACKGROUND

“Cloud computing” services provide shared resources, software, and information to computers and other devices upon request. In cloud computing environments, software can be accessible over the Internet rather than installed locally on in-house computer systems. Cloud computing typically involves over-the-Internet provision of dynamically scalable and often virtualized resources. Technological details can be abstracted from the users, who no longer have need for expertise in, or control over, the technology infrastructure “in the cloud” that supports them.

### BRIEF DESCRIPTION OF THE DRAWINGS

The included drawings are for illustrative purposes and serve only to provide examples of possible structures and operations for the disclosed inventive systems, apparatus, methods and computer readable media for managing objectives associated with an organization. These drawings in no way limit any changes in form and detail that may be made by one skilled in the art without departing from the spirit and scope of the disclosed implementations.

FIG. 1 shows a system diagram of an example of architectural components 100 for creating, managing, analyzing, and joining objectives in an organization according to some implementations.

FIG. 2 shows an example of a report associated with an objective according to some implementations.

FIG. 3 shows a flowchart of an example of creating objectives in an organization in accordance with some implementations.

FIG. 4 shows an example of a hierarchy of objectives in an organization according to some implementations.

FIGS. 5A and 5B show an example of a hierarchy of objectives in an organization according to some implementations.

FIG. 5C shows an example of a graphical user interface (GUI) including data from an objective record in accordance with some implementations.

FIGS. 6A and 6B show examples of hierarchies of objectives in an organization according to some implementations.

FIG. 7 shows a flowchart of an example of managing objectives in an organization in accordance with some implementations.

FIG. 8A shows a block diagram of an example of an environment 10 in which an on-demand database service can be used in accordance with some implementations.

FIG. 8B shows a block diagram of an example of some implementations of elements of FIG. 8A and various possible interconnections between these elements.

FIG. 9A shows a system diagram illustrating an example of architectural components of an on-demand database service environment 1200 according to some implementations.

FIG. 9B shows a system diagram further illustrating an example of architectural components of an on-demand database service environment according to some implementations.

### DETAILED DESCRIPTION

Examples of systems, apparatus, and methods according to the disclosed implementations are described in this section. These examples are being provided solely to add context and aid in the understanding of the disclosed implementations. It will thus be apparent to one skilled in the art that implementations may be practiced without some or all of these specific details. In other instances, certain process/method operations, also referred to herein as “blocks,” have not been described in detail in order to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the blocks of methods shown and described herein are not necessarily performed in the order indicated. It should also be understood that the methods may include more or fewer blocks than are indicated. In some implementations, blocks described herein as separate blocks may be combined. Conversely, what may be described herein as a single block may be implemented in multiple blocks.

Various implementations described or referenced herein are directed to different systems, apparatus, methods, and computer-readable storage media for creating, managing, analyzing, and joining objectives in an organization. For example, a member of an organization may provide data indicating an objective to a server. The server may store the data associated with the objective with data associated with other objectives created by other members of the organization. In this way, objectives with an organization may be created. Additionally, the objectives may include relationships with each other. For example, one objective may be indicated as a parent objective of other child objectives. Accordingly, a hierarchy of objectives within the organization may be provided, for example, for display on a computing device. The objective hierarchy may be displayed in a graphical user interface (GUI) with parent objectives being associated with child objectives. Each objective may include a completion indicator providing an indication as to the progress of completing the objective. Moreover, objectives may be “highlighted,” or emphasized, in the GUI in order to show various attributes of the objectives.

In some instances, each objective may be associated with a report that provides a metric to compute the completion indicator. The metric may be based on data in a record, such as a CRM record.

As an example, John Smith may be a salesman at MegaCorp. John Smith may create an objective, such as “Increase sales by 10%” and provide data (e.g., the objective name, completion date, his name as the creator, etc.) associated with the objective to a server for storage. Additionally, John Smith may create a report tying the objective to a CRM record in a CRM database. For example, the objective “Increase sales by 10%” may be associated with sales records of the organization. As an example, each customer of the organization may include its own sales record including data on sales to the customer. Accordingly, John Smith may tie the objective to the sales records of the organization's clients with a report specifying that the objective is to be associated with particular fields or data provided by the sales records. As such, the objective “Increase sales by 10%” may be tied data in the CRM database. As an example, “Increase sales by 10%” may be tied to data indicating the amount of sales for each particular client and completion of the objective being that the sales for all the clients in the aggregate to increase by 10%. Accordingly, a completion indicator (e.g., a graphical meter, percentage, etc.) associated with the objective may be based on the data in the DRM database. As the number of sales to the clients increase, the completion indicator may likewise increase (e.g., increase in percentage towards completion of the objective). As such, John Smith may create an objective, associate the objective with a report with metrics based on data from the CRM database, and provide a completion indicator based on the metrics.

Additionally, the objective may be associated with other objectives. For example, John Smith may “align” his objective with another objective. As an example, John Smith may indicate his objective, “Increase sales by 10%,” may be aligned with “Increase overall company performance” by another member of the organization. Accordingly, the objective “Increase sales by 10%” may be a child objective to a parent objective “Increase overall company performance.” The parent objective “Increase overall company performance” may also include a completion indicator that may be based on the completion indicator of “Increase sales by 10%.” For example, parent objective “Increase overall company performance” may be at 15% completion and include four children objectives aligned with it, including “Increase sales by 10%.” When “Increase sales by 10%” has a completion indicator that may increase, for example, from 50% to 75%, a completion indicator for “Increase overall company performance” may increase, for example, from 15% to 22% based on the increase from “Increase sales by 10%.” Accordingly, the progress of child objectives may percolate up to parent objectives.

Additionally, because the objectives may include relationships with each other through alignments, a hierarchy of the objectives may be displayed in a GUI. For example, “Increase overall company performance” may be a higher level of an objective hierarchy than “Increase sales by 10%” because “Increase sales by 10%” was indicated to be a child objective of the parent objective “Increase overall company performance.” Accordingly, a GUI providing a display of the objectives in the organization may be provided. Certain objectives may also be “highlighted,” or emphasized, to indicate various conditions and/or attributes of the objectives in the hierarchy.

As an example, a hierarchy may include several levels of objectives aligned with each other. For example, a hierarchy may include a parent objective with child objectives. The child objectives may include their own child objectives, which may be grandchild objectives for the parent objective. Additionally, the grandchild objectives of the parent objective may further include their own child objectives (i.e., great-grandchildren objectives of the parent objective). Accordingly, an organization may have a large objective hierarchy that may be provided by a GUI. However, certain conditions and/or attributes of the objectives in the objective hierarchy may be determined to meet a threshold number or other factor, and therefore, the objective may be highlighted in the hierarchy.

For example, a member of the organization may be viewing the GUI portraying the objective hierarchy. The member may wish to view the hierarchy of objectives with the objectives lower than 25% completion emphasized to see which objectives in the organization are behind schedule. Accordingly, the GUI may highlight, shade, color, animate, etc. portions of the hierarchy such that the member of the organization may be easily able to determine the objectives which are below 25% completion.

These and other implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

Online social networks are increasingly becoming a common way to facilitate communication among people who can be recognized as users of a social networking system. Some online social networks can be implemented in various settings, including organizations, e.g., enterprises such as companies or business partnerships, academic institutions, or groups within such an organization.

In some online social networks, users can access one or more social network feeds, which include information updates presented as items or entries in the feed. Such a feed item can include a single information update or a collection of individual information updates. A feed item can include various types of data including character-based data, audio data, image data and/or video data. For example, a post related to an online marketing campaign may appear as a feed item. A social network feed can be displayed in a graphical user interface (GUI) on a display device such as the display of a computing device as described below. The information updates can include various social network data from various sources and can be stored in an on-demand database service environment. In some implementations, the disclosed methods, apparatus, systems, and computer-readable storage media may be configured or designed for use in a multi-tenant database environment.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

A “user profile” or “user's profile” is generally configured to store and maintain data about a given user of the database system. The data can include general information, such as name, title, phone number, a photo, a biographical summary, and a status, e.g., text describing what the user is currently doing. As mentioned below, the data can include messages created by other users. Where there are multiple tenants, a user is typically associated with a particular tenant. For example, a user could be a salesperson of a company, which is a tenant of the database system that provides a database service.

The term “record” generally refers to a data entity, such as an instance of a data object created by a user of the database service, for example, about a particular (actual or potential) business relationship or project. The data object can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “social network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different social network feeds. A second user following a first user and a record can receive the feed items associated with the first user and the record for display in the second user's news feed, which is another type of social network feed. In some implementations, the feed items from any number of followed users and records can be combined into a single social network feed of a particular user.

As examples, a feed item can be a message, such as a user-generated post of text data, and a feed tracked update to a record or profile, such as a change to a field of the record. Feed tracked updates are described in greater detail below. A feed can be a combination of messages and feed tracked updates. Messages include text created by a user, and may include other data as well. Examples of messages include posts, user status updates, and comments. Messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a graphical user interface (GUI), for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group. In one implementation, there is only one status for a record.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Messages and feed updates can be stored as a field or child object of the record. For example, the feed can be stored as a child object of the record.

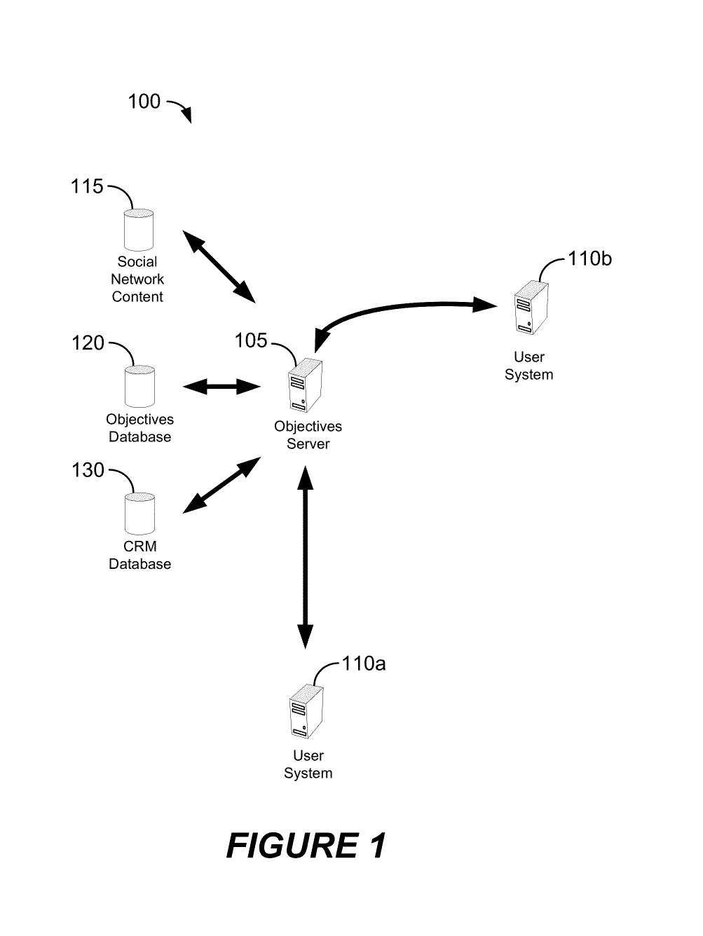

FIG. 1 shows a system diagram of an example of architectural components 100 for creating, managing, analyzing, and joining objectives in an organization according to some implementations. Architectural components 100 in FIG. 1 may provide communications to be transmitted among a variety of different hardware and/or software components. For example, architectural components 100 may include objectives server 105, user system 110a, user system 110b, social network content 115, objectives database 120, and CRM database 130.

User systems 110a and 110b may be any type of computing device. For example, user systems 110a and 110b may be portable electronic devices such as smartphones, tablets, laptops, wearable devices (e.g., smart watches), etc. User systems 110a and 110b may be another server or a desktop computer. Additionally, user systems 110a and 110b may be different types of computing devices. For example, user system 110a may be a desktop computer whereas user system 110b may be a smartphone.

In some implementations, objectives server 105 may receive requests from user system 110a and 110b, analyze the requests, and obtain and/or store data in social network content 115, objectives database 120, and CRM database 130. User system 110a and user system 110b may obtain data from objectives server 105 and provide information to a user, for example, via a display. Accordingly, various components are able to communicate with each other, for example, over the Internet or a combination of networks including the Internet.

As an example, objectives server 105 may receive, from user system 110a, data regarding an objective in an organization. For example, the data may include an objective, such as “Introduce feature X,” start and end dates, description of the objective, the visibility of the objective within the organization, key results to achieve the objective, potential contributors, a message to send to contributors to invite them to join the objective, and other types of data. Additionally, the objective may be indicated as being associated with another objective in the organization, for example, as being “aligned” (i.e., set as a child objective) to the other objective (i.e., the parent objective). Moreover, the objective may be associated with a report tying the objective to a metric based on data from CRM database 130. The data regarding the objective may be stored by objectives server 105 on objectives database 120. Additionally, objective server 105 may retrieve and transmit data to user system 110b. For example, data regarding an objective provided by user system 110a may be obtained by user system 110b.

In some implementations, objectives server 105 may also transmit data to social network server 115. For example, a message may be posted on a social network feed on a social network that an objective was received from user system 110a. In some implementations, user system 110b may interact with the message on the social network.

Additionally, objectives server 105 may retrieve and analyze data from CRM database 130. For example, user system 110a may create an objective such as “Generate ten sales leads.” Data regarding the objective may be stored in objectives database 120. Content may also be posted on a social network by storing the data in social network content 115. Additionally, objectives server 105 may query CRM database 130 to determine the progress of the objective. For example, CRM database 130 may include sales and marketing data. Objectives server 105 may determine that the objective's progress may be tied to the sales and marketing data, and has progressed a particular amount, and therefore, update the associated data in objectives server 105. Objectives server 105 may also transmit data regarding the progress of the objective to social network content 115. For example, a message may be posted to a social network that the objective is 50% towards completion. In other implementations, the objectives may be displayed in a graphical user interface (GUI) and indicated that the particular objective is 50% towards completion in the GUI.

As an example, user system 110a may provide an objective “Become the Number One Transmogrifier Dealer in North America!” The objective “Become the Number One Transmogrifier Dealer in North America!” may include a start date of Jan. 1, 2014, an end date of Dec. 31, 2014, a description of “Let's sell the most amount of transmogrifiers in Canada, the United States, and Mexico,” and may be indicated as visible to all employees in the organization. User system 110a may also associate the objective with records in CRM database 130 associated with clients, such as a sales record for clients “Widgets For All” and “Widgets For Less.” For example, user system 110a may associate objective “Become the Number One Transmogrifier Dealer in North America!” to data in the sales records, for example, by creating a report.

In some implementations, the report may tie the objective to a metric based on data from CRM database 130. For example, user system 110a may indicate that particular data in the sales records for Widgets For All and Widgets For Less in CRM database 130 may be associated with the objective. As an example, “Become the Number One Transmogrifier Dealer in North America!” may have a completion indicator marking its progress towards finishing the objective based on the number of transmogrifiers sold as indicated in the sales records for Widgets For All and Widgets For Less in CRM database 130. For example, each sales record may include a “widgets sold” field with data providing the number of widgets sold to the customer associated with the sales record. As such, the report for the objective “Become the Number One Transmogrifier Dealer in North America” may allow the completion indicator providing progress towards completion of the objective be based on the “widgets sold” field from the sales records associated with Widgets For All and Widgets For Less. When the “widgets sold” field in the sales records associated with Widgets For All and Widgets For Less changes, for example when updated by a salesman, the completion indicator for the objective may also change. For example, if the report indicates that the objective is complete upon the number of widgets sold in the “widgets sold” fields in the sales records associated with Widgets For All and Widgets For Less reaching one hundred total widgets, and if the sales records indicate that fifty widgets have been sold, the completion indicator may indicate 50% progress towards completion of the objective. Accordingly, the data in CRM database 130 may be associated with objectives in objectives database 120.

User systems 110a and 110b may also obtain data providing a hierarchy of objectives in the organization. For example, user system 110b may request to see a hierarchy of the entire organization, or a sub-hierarchy with a particular objective at the highest level of the objective hierarchy. As an example, data for the objective “Become the Number One Transmogrifier Dealer in North America!” may be stored in objectives database 120. Another objective, such as “Increase sales to Widgets-R-Us” may be created, for example, by user system 110b. User system 110b may indicate that “Increase sales to Widgets-R-Us” is aligned with “Become the Number One Transmogrifier Dealer in North America!” Accordingly, “Increase sales to Widgets-R-Us” may be indicated as being a child objective of a parent objective “Become the Number One Transmogrifier Dealer in North America!” As such, a hierarchy of objectives may be created, with parent objectives being at a higher level of the objective hierarchy than child objectives. User systems 110a and 110b may be provided data associated with the objective hierarchy, for example, in a GUI for display on a computing device. Accordingly, the objectives of the organization may be visualized.

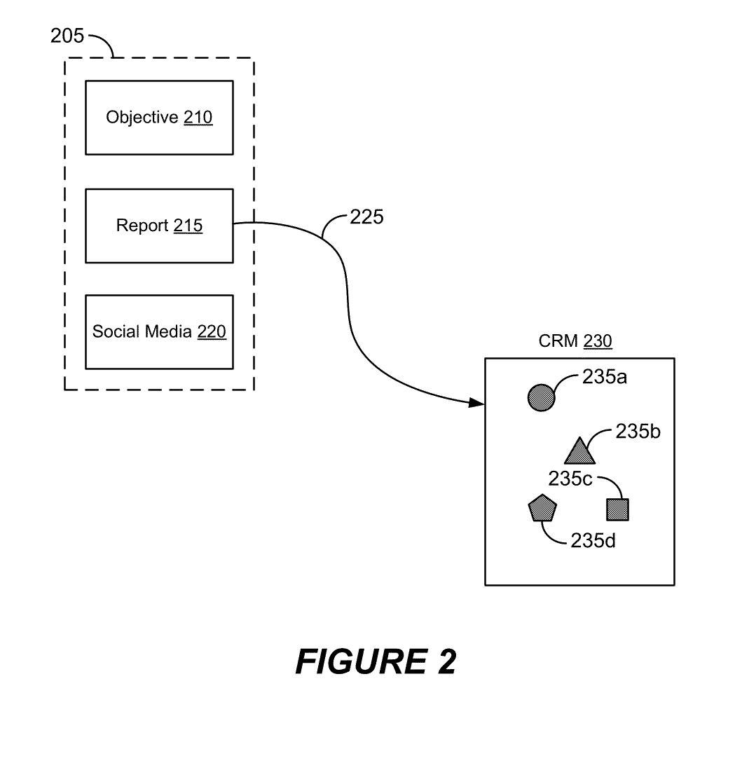

FIG. 2 shows an example of a report associated with an objective according to some implementations. In FIG. 2, association 205 includes objective 210, report 215, and social media 220. In an implementation, each objective 210 is associated with a report 215 and social media 220. For example, an objective 210 may be “Make Sales in Lithuania” and its associated data. Report 215 may be associated with objective 210. For example, when the “Make Sales in Lithuania” objective was created, a report may also be created. The report may indicate that a metric associated with a record in CRM 230 provides data to determine the progress of a completion indicator associated with the objective “Make Sales in Lithuania.” The metric may specify particular records in CRM 230 and particular fields of the records in the CRM.

For example, in FIG. 2, CRM 230 includes records 235a, 235b, 235c, and 235d. The records may be related towards sales, opportunities, accounts, cases, contacts, or other types of records As an example, each of records 235a, 235d, 235c, and 235d may be associated with separate Lithuanian clients of an organization. Each record may be a sales record with a field of “net sales.” Report 215 may provide metric, or a formula, to determine the progress of the completion of the objective based on the “net sales” field in CRM 230. For example, a metric may be that “net sales” of each client represented by records 235a, 235b, 235c, and 235d increases by 10%, the overall “net sales” of each client in the aggregate increases by 10%, and so forth.

Additionally, in association 205, objective 210 and report 215 may be associated with social media 220. In an implementation, the organization may include a social network. A message may be posted on a social network feed on the social network that an objective has changed in completion (e.g., increased progress towards completion, dropped in progress, etc.). Additionally, the social network feed may provide information that members of the organization have joined the objective. Accordingly, report 215 may provide a metric to determine the progress of the completion of the objective based on data in DRM 230. Because objective 210 and social media 220 are associated with report 215, an objective 210's completion indicator may be progressed and an update regarding the progress towards the completion of the objective may be posted on social media 220.

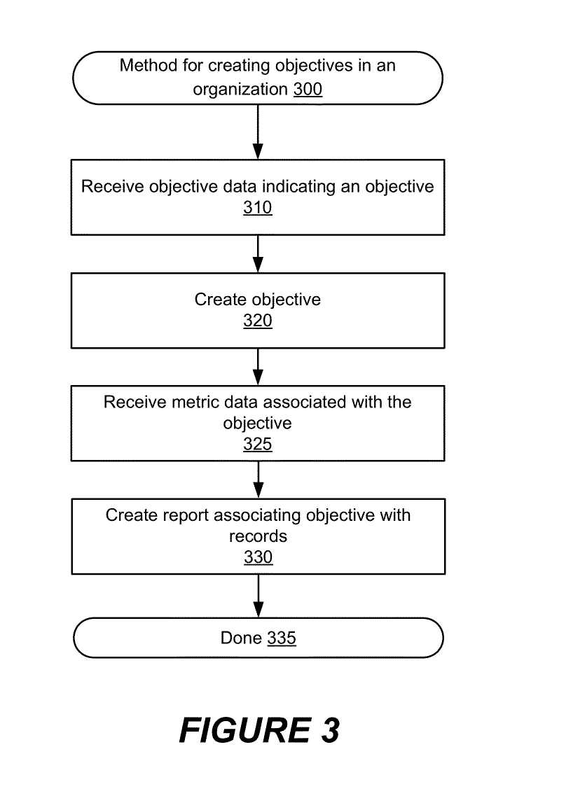

FIG. 3 shows a flowchart of an example of creating objectives in an organization in accordance with some implementations. Method 300 (and other methods described herein) may be implemented by the architectural components of FIG. 1. In various implementations, blocks may be reordered, omitted, combined, or split into additional blocks for method 300, as well as other methods described herein.

In block 310, objective data indicating an objective may be received, for example, as described in U.S. patent application Ser. No. 14/026,859, titled “Computer Implemented Methods and Apparatus for Managing Objectives in an Organization in a Social Network Environment,” by Gosling, et al., filed on Sep. 13, 2013, which is hereby incorporated by reference. Accordingly, in block 320, an objective may be created, and the associated data may be stored in objectives database 120. A story may also be posted on a social media feed provided by social network content 115.

In block 325, metric data associated with the objective may be received. As previously discussed, metric data may indicate an association of the objective to data in records stored by CRM database 130. As such, the progress of the objective towards completion may be based on data in CRM database 130.

In block 330, a report including the metric associated with an objective may be generated and stored, for example, in objectives database 120. In block 335, method 300 is done.

As previously discussed, a member of the organization may create an objective and provide an indication as to a relationship between the objective to other objectives. For example, an objective may be “aligned” with another objective such that it may be indicated as a child objective of the other objective. As another example, an objective may be indicated to be a parent objective of another objective. Accordingly, relationships between objectives in the organization may be established.

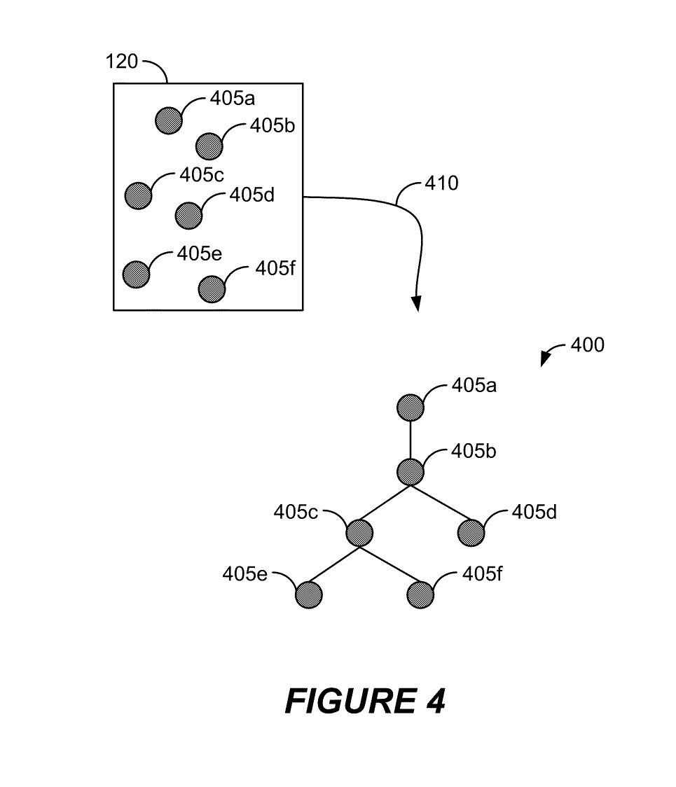

FIG. 4 shows an example of a hierarchy of objectives in an organization according to some implementations. In FIG. 4, hierarchy 400 is a hierarchy of objectives within the organization. For example, objectives 405a, 405b, 405c, 405d, 405e, and 405f may be provided as objectives, and therefore stored, in objectives database 120. Additionally, objectives 405a, 405b, 405c, 405d, 405e, and 405f may have a relationship with each other, and therefore, create a hierarchy of levels of objectives within the organization. Parent objectives may be at a higher level of the objective hierarchy than child objectives.

For example, in FIG. 4, objective 405a may be stored in objective database 120. Objective 405b may be created and indicated to be aligned, or a child objective, of objective 405a. Objectives 405c and 405d may be created and indicated to be aligned with objective 405b. Additionally, objectives 405e and 405f may be created and indicated to be aligned with objective 405c. Accordingly, hierarchy 400 in FIG. 4 visualizes child-parent relationships between the objectives in a hierarchy of objectives.

In some implementations, objectives 405e and 405f may be created and stored in objective database 120. Objective 405c may be created and indicated to be a parent objective of objectives 405e and 405f. That is, objectives 405e and 405f in objectives database 120 may be indicated to be children objectives of objective 405c, and therefore, at a lower level of the objective hierarchy. Objective 405d may be created and stored in objective database 120 with no indicated relationship to other objectives. However, objective 405b may be created and indicate a relationship with objective 405d. In the example of FIG. 4, objective 405b may be indicated as a parent objective of objectives 405c and 405d. Objective 405a may be created and stored in objectives database 120 and indicate that objective 405b is a child objective.

In other implementations, an objective may be created and have no relationship to other objectives in objectives database 120. In an implementation, multiple objective hierarchies may exist between objectives in objectives database 120.

In some implementations, an objective may indicate a relationship to other objectives which may cause relationships between the other objectives to change, or update. For example, objective 405a may be indicated as a parent objective of objectives 405c and 405d. However, objective 405b may be created and indicate that it is a parent objective of objectives 405c and 405d, and a child objective of objective 405a. Therefore, objectives 405c and 405d may be changed to be grandchildren objectives of objective 405a. In another implementation, objectives 405c and 405d may remain children objectives of objective 405a in one hierarchy, but another hierarchy may be created wherein objective 405b is a parent objective of objectives 405c and 405, and a child objective of objective 405a.

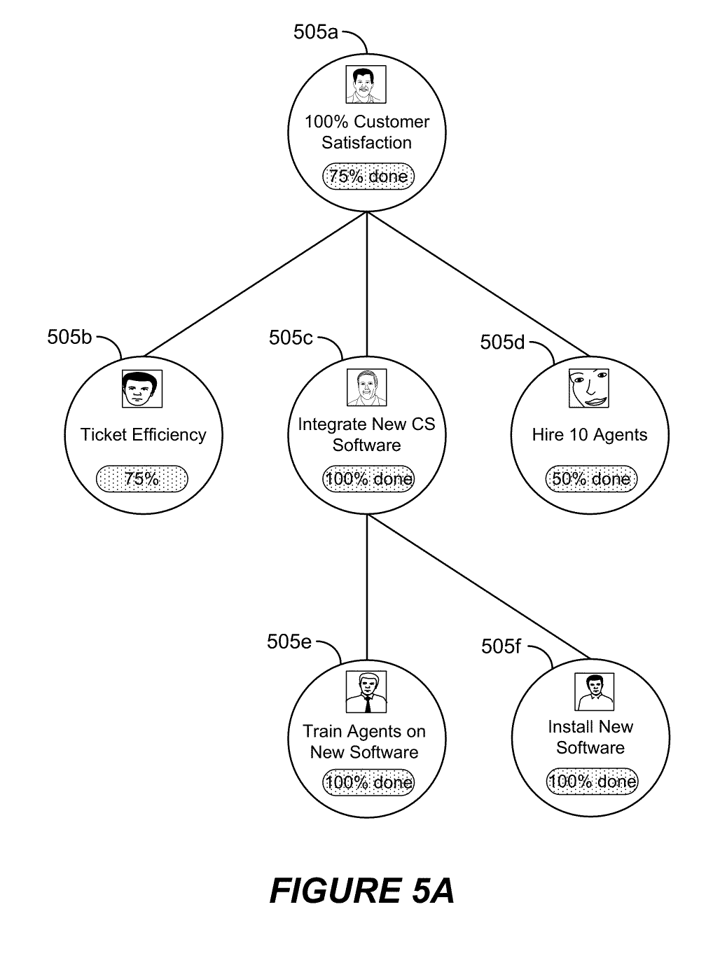

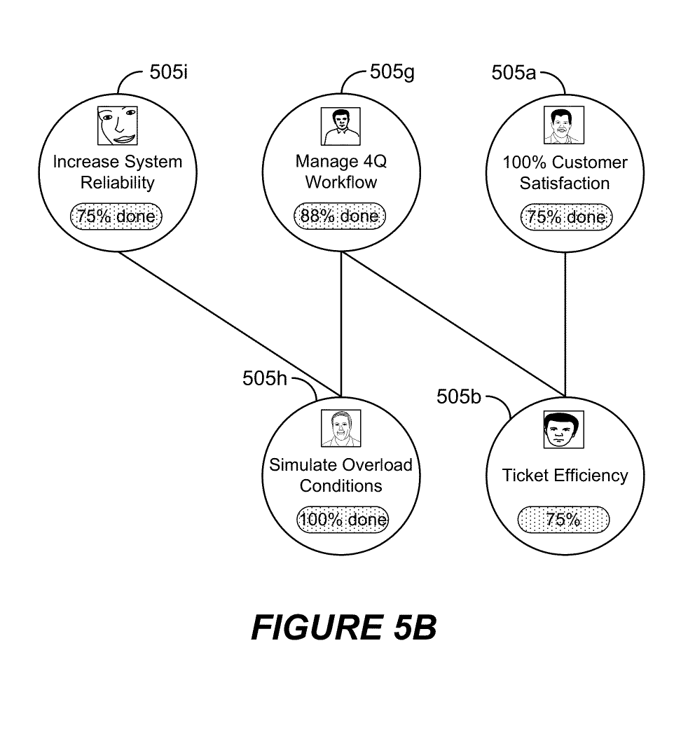

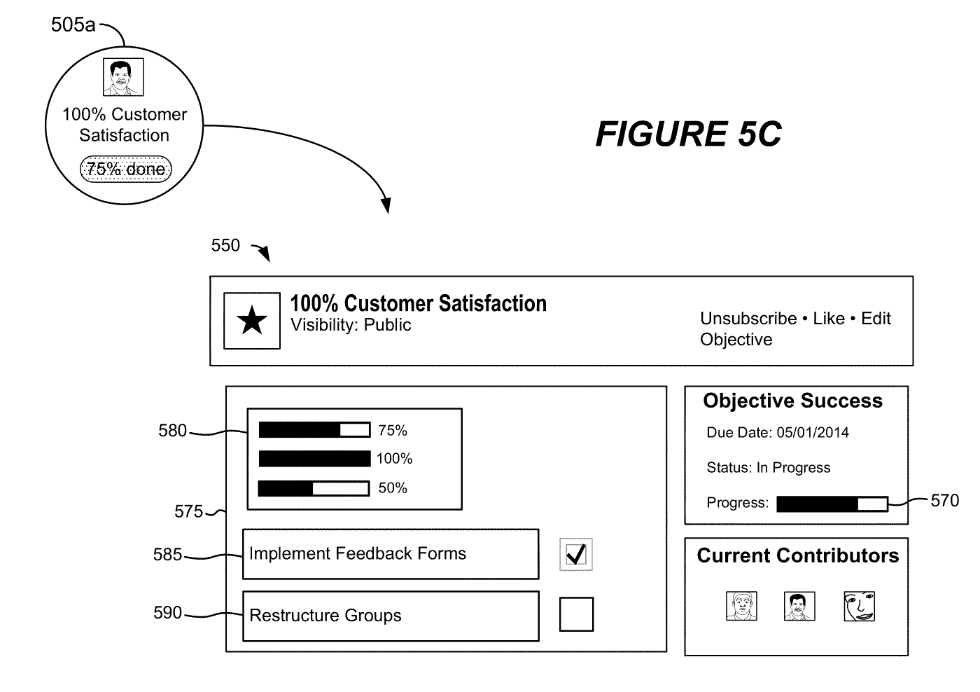

FIGS. 5A and 5B show a hierarchy of objectives in an organization according to some implementations. For example, FIG. 5A may be a GUI provided on a display on a computing device. In FIG. 5A, objective 505a, titled “100% Customer Satisfaction” is a parent objective of objective 505b, titled “Ticket Efficiency,” objective 505c, titled “Integrate New CS Software,” and objective 505d, titled “Hire 10 Agents.” Objective 505c is a parent objective of objective 505e, titled “Train Agents on New Software,” and objective 505f, titled “Install New Software.” Accordingly, multiple levels of an objective hierarchy are shown in FIG. 5A.

In FIG. 5A, each of objectives 505a, 505b, 505c, 505d, 505e, and 505f may include a completion indicator marking the progress of the objective towards completion. For example, objective 505a is marked as 75% done. Objective 505b is 75% done. Objective 505c is 100% done. Objective 505d is 50% done. Objectives 505e and 505f are both indicated as 100% done.

In some implementations, the completion of children objectives may affect the indicated progress of the parent objective. For example, in FIG. 5A, objective 505e and objective 505f are both 100% done. Since objectives 505e and 505f are the only children objectives of parent objective 505c, objective 505c may also be indicated as 100% done because the progress of objective 505c may be based on the progress of its children objectives (i.e., objectives 505e and 505f). In an implementation, a parent objective may be done when its children objectives are done. In another implementation, a completion of a parent objective may be based on the completion of children objective, as well as other metrics associated with objective 505c. For example, the progress of the children's objectives may contribute 50% of the total 100% towards completion of objective 505c. The remaining 50% may be based on, for example, metrics tying objective 505c to data in records in CRM database 130. In some implementations, objectives 505c, 505e, and 505f may all be associated with different records and/or types of data in CRM database 130.

As another example, in FIG. 5A, the progress of objective 505a may be based on the progress of objectives 505b, 505c, and 505d (i.e., the children objectives of objective 505a). If the progress of objectives 505e and 505f change, the progress of objective 505c may change, and therefore, the progress of objective 505a may also change.

In some implementations, an objective may be associated with multiple parent objectives. For example, objective 505g, titled “Manage 4Q Workflow” in FIG. 5B may be associated with or created by a member of the organization who is a Manager within an organizational hierarchy associated with the organization. Objective 505a, titled “100% Customer Satisfaction” may be an objective created by a Vice President in the organization. The Vice President may be at a higher level of the organizational hierarchy than the Manager. Objectives 505h and 505b may be created by engineers within the organization. The engineers may both be immediately under the manager in the organizational hierarchy (i.e., at a lower level or the organizational hierarchy). However, the engineers may align their created objectives to objectives created by members of the organization other than the Manager. For example, objective 505b, titled “Ticket Efficiency,” may be aligned with objective 505a, titled “100% Customer Satisfaction.” Objective 505h, titled “Simulate Overload Conditions,” may be aligned with objective 505i, titled “Increase System Reliability.” However, the Manager of the engineers may have objective 505g, titled “Manage 4Q Workflow,” to manage the resources and monitor the progress of his direct reports (i.e., the engineers who are underneath the manager in the organizational hierarchy). Accordingly, when objectives 505h and 505b are created by the engineers, their objectives may be further automatically aligned with their manager. As such, objectives may be aligned with subject matters created by members at any level of the organizational hierarchy (e.g., engineers aligning their objectives with people several levels above them such as the Vice President, aligning their objectives with objectives created by different departments or groups, etc.) but workflow may still be observed and managed by another objective (e.g., the manager's objective 505g).

FIG. 5C shows an example of a graphical user interface (GUI) including data from an objective record in accordance with some implementations. In an implementation, an objective within the objective hierarchy of FIG. 5A may be “drilled down” into to provide information associated with the objective. In some implementations, a variety of data may be provided in the GUI, such as social media content (e.g., feed items associated with the objective), data from the report associated with the objective, contributors to the objective, and any other type of data related to the objectives disclosed herein. In the example of FIG. 5C, data associated with the completion indicator of the objective is shown.

In FIG. 5C, completion indicator 570 indicates that objective 505a is 75% towards completion of the objective. The 75% progress may be based on the factors in window 575. For example, in FIG. 5C, window 575 includes children progress 580, which may be the progress of the children goals of objective 505a in FIG. 5A. Additionally, tasks 585 and 590 may also contribute towards the completion of the objective. That is, when the progress of the children objectives in children progress 580 are all 100%, and task 585 and task 590 (e.g., tasks to complete objective 505a in addition to the progress of the children objective) are checked, objective 505a may be 100% complete, and therefore, the objective may be finished. In some implementations, window 575 may show other date related to the objective, including the objective hierarchy or a portion of the objective hierarchy, content from social network content 115, etc. In some implementations, the tasks to complete the objective are associated with metrics, as previously discussed.

In some implementations, the tasks (e.g., the children objectives in children progress 580) and tasks 585 and 590 may have different weights, and therefore, contribute different amounts towards the completion of objective 505a. For example, the children objectives may each contribute 10% towards the completion of objective 505a. That is, the children objectives may collectively contribute 30% towards the completion. Task 585 may contribute 50% towards completion and task 590 may contribute 20% towards completion.

In some implementations, the tasks may also have “overages.” If a task is associated with a metric and the task is completed well above the expected level, the objective may be indicated as being over 100% complete. For example, if 50 widgets are to be sold according to an objective, but 100 widgets are sold, then the objective may be 200% complete. In some implementations, every task within the objective need not be completed in order to achieve a 100% completion for the objective. For example, if two tasks each contribute 50% towards the completion of the objective, and one is 200% complete and the other is 0% complete, then the objective may be indicated as 100% complete despite one task not being completed.

Additionally, a user completing the first task may be awarded a “badge,” points, or other forms of accomplishment to encourage users to participate in objectives of the organization.

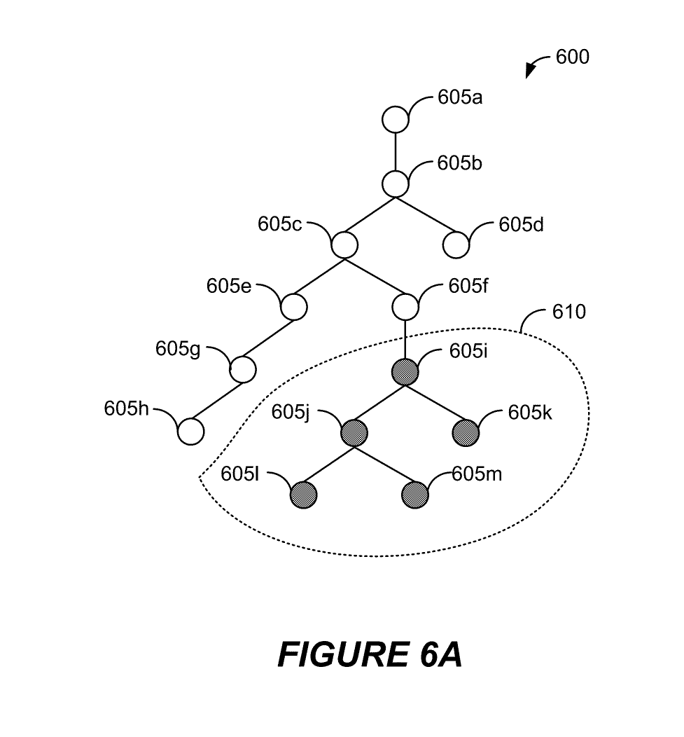

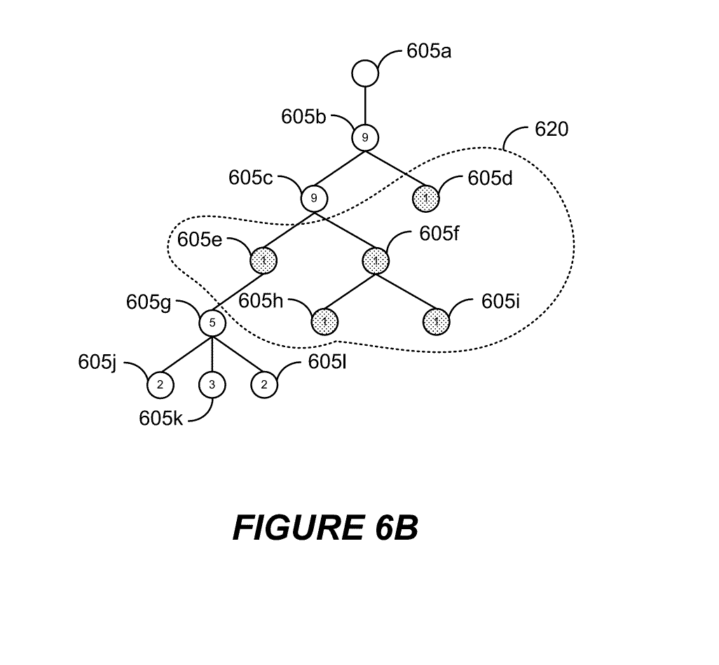

FIGS. 6A and 6B show examples of hierarchies of objectives in an organization according to some implementations. In FIG. 6A, hierarchy 600 may include objectives 605a-m. The GUI displaying hierarchy 600 may be able to emphasize a variety of objectives such that particular objectives may be easily viewed and managed based on characteristics of the objectives. For example, in FIG. 6A, objectives in the hierarchy which are behind schedule may be emphasized. In FIG. 6A, objectives 605i-m in subgroup 600 are shaded to indicate that they are behind schedule. For example, user system 110a may obtain data from objectives database 120 and display a hierarchy of objectives in a GUI on a display. User system 110a may specify a particular percentage, such as 50%, and the GUI may emphasize objectives which are below 50%.

In some implementations, the objectives which are emphasized as behind schedule may be based on the beginning and end date of the highest-level objective in the hierarchy. For example, the highest objective may have a start date and end date indicating a one-year period for the completion of the highest objective. At the midpoint of the one-year period, objectives which are below 50% may be emphasized. If it is three-fourths into the one-year period, objectives which are below 75% may be emphasized. Accordingly, an alert may be provided when an objective is behind schedule, and therefore, the organization may prioritize allocating resources and encourage members to join the objective to bring it back within schedule. In other implementations, objectives which are ahead of schedule or within schedule may be emphasized. In some implementations, objectives with a completion below a threshold percentage may be indicated as critical, and therefore, emphasized in the various ways described herein.

In some implementations, objectives may be emphasized by highlighting, shading, coloring, changing colors, animating, or any other visual method to emphasize objectives as to provide an alert to particular situations. In one implementation, a hierarchy may be pruned (i.e., objectives removed) in order to emphasize the remaining objectives.

In some implementations, other characteristics of objectives may be emphasized. For example, objectives created by certain types of employees may be emphasized. As an example, objectives created by engineers may be emphasized. In other implementations, objectives created by artists, marketing associates, attorneys, executives, and/or any other role within the organization may be emphasized. In some implementations, objectives with contributors who are not creators of the objective may be emphasized based on the roles within the organization. For example, an objective may be created by a marketing professional, but an engineering professional within the organization may join to contribute to the objective. The GUI may emphasize objectives which have engineering professionals contributing, and therefore, the objective created by the marketing professional may be emphasized.

In some implementations, a member of the organization at a particular level of the organizational hierarchy may emphasize objectives created by and/or joined by members of the organization who are at a lower level of the hierarchy, or a higher level of the hierarchy. For example, a manager may emphasize the objectives created by and/or joined by the manager's direct reports (e.g., those who are one level beneath the manager within the organizational hierarchy). As another example, the manager's direct reports may emphasize the objectives created by the manager. As another example, every objective created by a member of the organization at a higher level of the organizational hierarchy may be emphasized. In another implementation, every objective created by a member of the organization at a lower level of the organizational hierarchy may be emphasized. In another implementation, every objective created by a member of the organization at the same level of the organizational hierarchy may be emphasized. In another implementation, every objective created by a member of the organization within the same group as a member using the GUI may be emphasized.

In an implementation, each objective may be associated with a priority. For example, the organization may indicate particular objectives as important, for example, those which are important to the organization's objectives, those which are behind schedule, need additional contributors, and so forth. Accordingly, the GUI in FIG. 6A may emphasize objectives which are at or above a particular priority level.

In FIG. 6B, objectives may be emphasized based on a number of contributors. For example, in FIG. 6B, objectives 605d-605i in subgroup 620 may be emphasized because they only have one contributor each. In some implementations, objectives with less than a particular number of contributors provided by user system 110a may be emphasized. As such, objectives which need more contributors may be emphasized to encourage members of the organization viewing the GUI to join the objectives. Accordingly, an alert associated with the objective may be provided to emphasize that it has a low number of contributors.

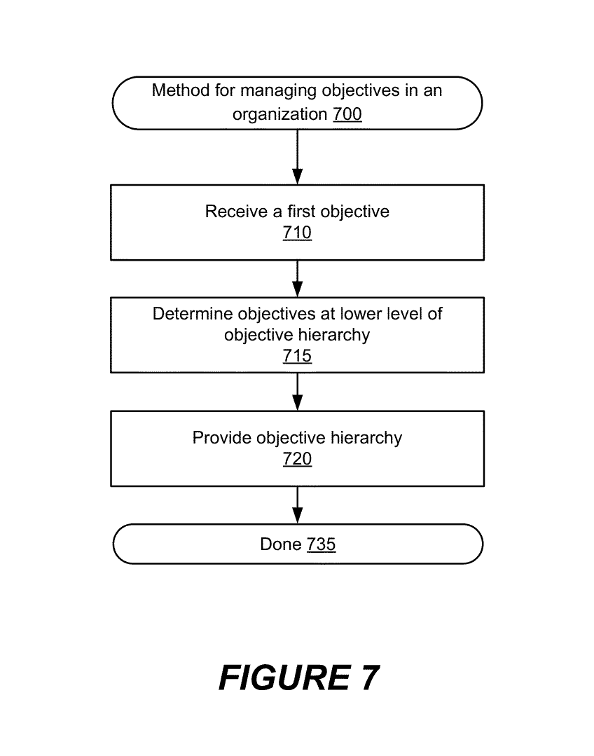

FIG. 7 shows a flowchart of an example of managing objectives in an organization in accordance with some implementations. In method 700, at block 710, a first objective may be received. For example, an objective at a highest level of an objective hierarchy may be received. In another example, a particular objective at a particular level within the hierarchy may be received.

Accordingly, in block 715, objectives at a lower level of the objective hierarchy may be determined. For example, the objectives at the level beneath the first objective may be determined. At block 720, the objective hierarchy including the first objective and the objectives at the lower level beneath the first objective may be provided, for example, for display on a computing device. At block 735, the method is done.

Mechanisms and methods for providing systems implementing enterprise level social and business information networking are disclosed herein with reference to several implementations. Examples of database systems are described and can provide a platform for tracking events related to a record, actions of a user, and messages about a user or record. The disclosed systems support various data structures of feeds, the customization of feeds, selection of records and users to follow, generation of feeds, and display of feeds in suitable presentations on a user's display device.

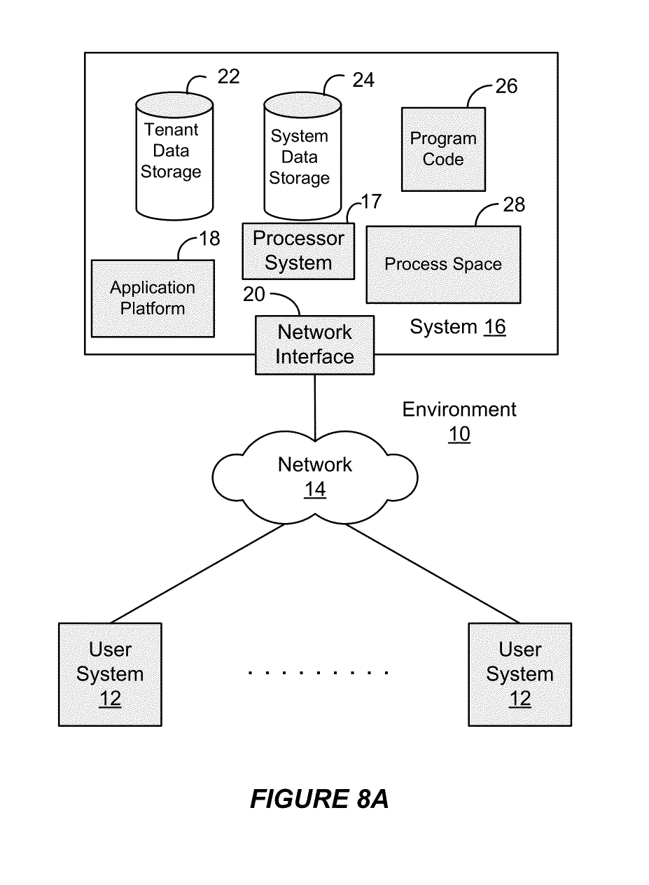

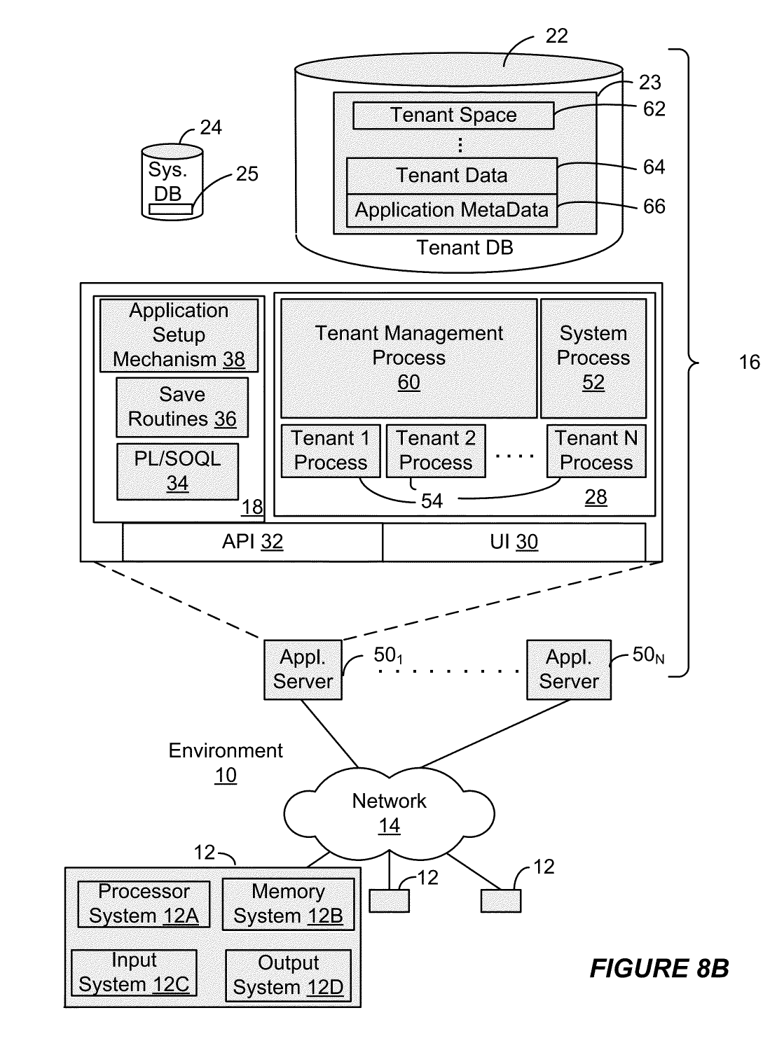

FIG. 8A shows a block diagram of an example of an environment 10 in which an on-demand database service can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

Environment 10 is an environment in which an on-demand database service exists. User system 12 may be implemented as any computing device(s) or other data processing apparatus such as a machine or system that is used by a user to access a database system 16. For example, any of user systems 12 can be a handheld computing device, a mobile phone, a laptop computer, a work station, and/or a network of such computing devices. As illustrated in FIG. 8A (and in more detail in FIG. 8B) user systems 12 might interact via a network 14 with an on-demand database service, which is implemented in the example of FIG. 8A as database system 16.

An on-demand database service, implemented using system 16 by way of example, is a service that is made available to outside users, who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 8A, implements a web-based customer relationship management (CRM) system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 8A and 8B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 8A include conventional, well-known elements that are explained only briefly here. For example, each user system 12 could include a desktop personal computer, workstation, laptop, PDA, tablet, smartphone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to a computing device or system, including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 8B shows a block diagram of an example of some implementations of elements of FIG. 8A and various possible interconnections between these elements. That is, FIG. 8B also illustrates environment 10. However, in FIG. 8B elements of system 16 and various interconnections in some implementations are further illustrated. FIG. 8B shows that user system 12 may include processor system 12A, memory system 12B, input system 12C, and output system 12D. FIG. 8B shows network 14 and system 16. FIG. 8B also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 8A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 8B, system 16 may include a network interface 20 (of FIG. 8A) implemented as a set of HTTP application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

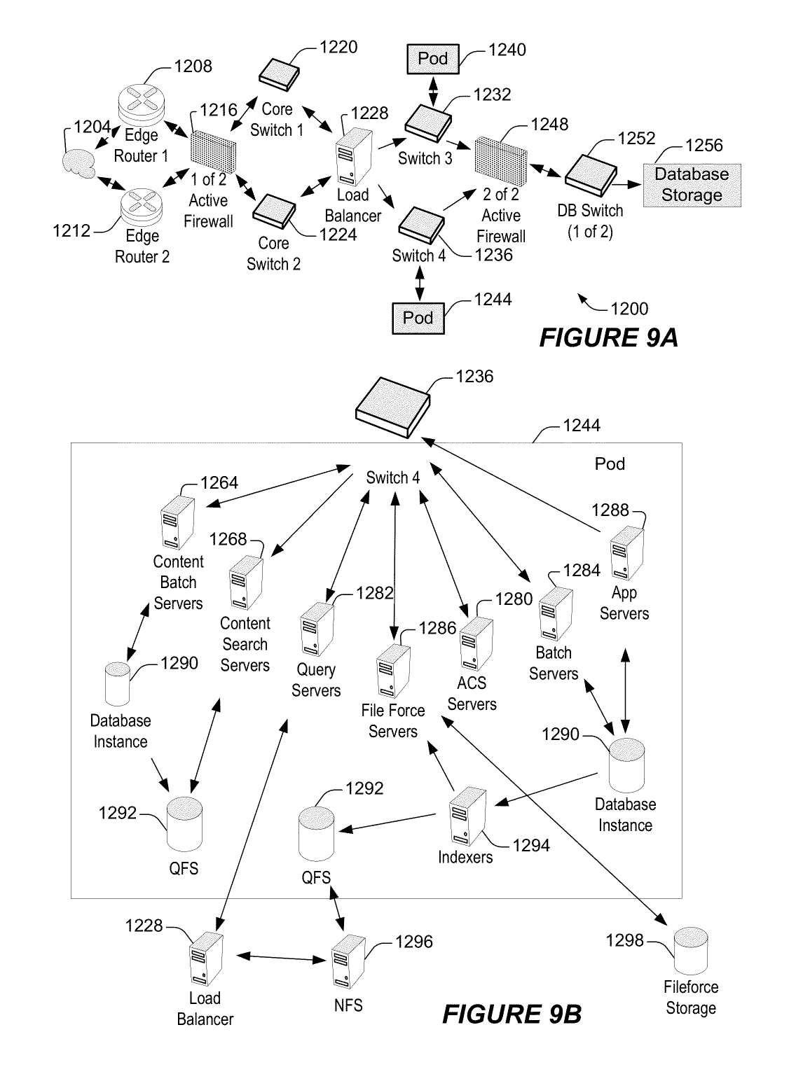

FIG. 9A shows a system diagram illustrating an example of architectural components of an on-demand database service environment 1200 according to some implementations. A client machine located in the cloud 1204, generally referring to one or more networks in combination, as described herein, may communicate with the on-demand database service environment via one or more edge routers 1208 and 1212. A client machine can be any of the examples of user systems 12 described above. The edge routers may communicate with one or more core switches 1220 and 1224 via firewall 1216. The core switches may communicate with a load balancer 1228, which may distribute server load over different pods, such as the pods 1240 and 1244. The pods 1240 and 1244, which may each include one or more servers and/or other computing resources, may perform data processing and other operations used to provide on-demand services. Communication with the pods may be conducted via pod switches 1232 and 1236. Components of the on-demand database service environment may communicate with a database storage 1256 via a database firewall 1248 and a database switch 1252.

As shown in FIGS. 9A and 9B, accessing an on-demand database service environment may involve communications transmitted among a variety of different hardware and/or software components. Further, the on-demand database service environment 1200 is a simplified representation of an actual on-demand database service environment. For example, while only one or two devices of each type are shown in FIGS. 9A and 9B, some implementations of an on-demand database service environment may include anywhere from one to many devices of each type. Also, the on-demand database service environment need not include each device shown in FIGS. 9A and 9B, or may include additional devices not shown in FIGS. 9A and 9B.

Moreover, one or more of the devices in the on-demand database service environment 1200 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 1204 is intended to refer to a data network or plurality of data networks, often including the Internet. Client machines located in the cloud 1204 may communicate with the on-demand database service environment to access services provided by the on-demand database service environment. For example, client machines may access the on-demand database service environment to retrieve, store, edit, and/or process information.

In some implementations, the edge routers 1208 and 1212 route packets between the cloud 1204 and other components of the on-demand database service environment 1200. The edge routers 1208 and 1212 may employ the Border Gateway Protocol (BGP). The BGP is the core routing protocol of the Internet. The edge routers 1208 and 1212 may maintain a table of IP networks or ‘prefixes’, which designate network reachability among autonomous systems on the Internet.

In one or more implementations, the firewall 1216 may protect the inner components of the on-demand database service environment 1200 from Internet traffic. The firewall 1216 may block, permit, or deny access to the inner components of the on-demand database service environment 1200 based upon a set of rules and other criteria. The firewall 1216 may act as one or more of a packet filter, an application gateway, a stateful filter, a proxy server, or any other type of firewall.

In some implementations, the core switches 1220 and 1224 are high-capacity switches that transfer packets within the on-demand database service environment 1200. The core switches 1220 and 1224 may be configured as network bridges that quickly route data between different components within the on-demand database service environment. In some implementations, the use of two or more core switches 1220 and 1224 may provide redundancy and/or reduced latency.

In some implementations, the pods 1240 and 1244 may perform the core data processing and service functions provided by the on-demand database service environment. Each pod may include various types of hardware and/or software computing resources. An example of the pod architecture is discussed in greater detail with reference to FIG. 9B.

In some implementations, communication between the pods 1240 and 1244 may be conducted via the pod switches 1232 and 1236. The pod switches 1232 and 1236 may facilitate communication between the pods 1240 and 1244 and client machines located in the cloud 1204, for example via core switches 1220 and 1224. Also, the pod switches 1232 and 1236 may facilitate communication between the pods 1240 and 1244 and the database storage 1256.

In some implementations, the load balancer 1228 may distribute workload between the pods 1240 and 1244. Balancing the on-demand service requests between the pods may assist in improving the use of resources, increasing throughput, reducing response times, and/or reducing overhead. The load balancer 1228 may include multilayer switches to analyze and forward traffic.

In some implementations, access to the database storage 1256 may be guarded by a database firewall 1248. The database firewall 1248 may act as a computer application firewall operating at the database application layer of a protocol stack. The database firewall 1248 may protect the database storage 1256 from application attacks such as structure query language (SQL) injection, database rootkits, and unauthorized information disclosure.

In some implementations, the database firewall 1248 may include a host using one or more forms of reverse proxy services to proxy traffic before passing it to a gateway router. The database firewall 1248 may inspect the contents of database traffic and block certain content or database requests. The database firewall 1248 may work on the SQL application level atop the TCP/IP stack, managing applications' connection to the database or SQL management interfaces as well as intercepting and enforcing packets traveling to or from a database network or application interface.

In some implementations, communication with the database storage 1256 may be conducted via the database switch 1252. The multi-tenant database storage 1256 may include more than one hardware and/or software components for handling database queries. Accordingly, the database switch 1252 may direct database queries transmitted by other components of the on-demand database service environment (e.g., the pods 1240 and 1244) to the correct components within the database storage 1256.

In some implementations, the database storage 1256 is an on-demand database system shared by many different organizations. The on-demand database system may employ a multi-tenant approach, a virtualized approach, or any other type of database approach. An on-demand database system is discussed in greater detail with reference to FIGS. 8A and 8B.

FIG. 9B shows a system diagram further illustrating an example of architectural components of an on-demand database service environment according to some implementations. The pod 1244 may be used to render services to a user of the on-demand database service environment 1200. In some implementations, each pod may include a variety of servers and/or other systems. The pod 1244 includes one or more content batch servers 1264, content search servers 1268, query servers 1282, file force servers 1286, access control system (ACS) servers 1280, batch servers 1284, and app servers 1288. Also, the pod 1244 includes database instances 1290, quick file systems (QFS) 1292, and indexers 1294. In one or more implementations, some or all communication between the servers in the pod 1244 may be transmitted via the switch 1236.

In some implementations, the app servers 1288 may include a hardware and/or software framework dedicated to the execution of procedures (e.g., programs, routines, scripts) for supporting the construction of applications provided by the on-demand database service environment 1200 via the pod 1244. In some implementations, the hardware and/or software framework of an app server 1288 is configured to execute operations of the services described herein, including performance of the blocks of methods described with reference to FIGS. 1-7. In alternative implementations, two or more app servers 1288 may be included and cooperate to perform such methods, or one or more other servers described herein can be configured to perform the disclosed methods.

The content batch servers 1264 may handle requests internal to the pod. These requests may be long-running and/or not tied to a particular customer. For example, the content batch servers 1264 may handle requests related to log mining, cleanup work, and maintenance tasks.

The content search servers 1268 may provide query and indexer functions. For example, the functions provided by the content search servers 1268 may allow users to search through content stored in the on-demand database service environment.

The file force servers 1286 may manage requests for information stored in the Fileforce storage 1298. The Fileforce storage 1298 may store information such as documents, images, and basic large objects (BLOBs). By managing requests for information using the file force servers 1286, the image footprint on the database may be reduced.

The query servers 1282 may be used to retrieve information from one or more file systems. For example, the query system 1282 may receive requests for information from the app servers 1288 and then transmit information queries to the NFS 1296 located outside the pod.

The pod 1244 may share a database instance 1290 configured as a multi-tenant environment in which different organizations share access to the same database. Additionally, services rendered by the pod 1244 may call upon various hardware and/or software resources. In some implementations, the ACS servers 1280 may control access to data, hardware resources, or software resources.

In some implementations, the batch servers 1284 may process batch jobs, which are used to run tasks at specified times. Thus, the batch servers 1284 may transmit instructions to other servers, such as the app servers 1288, to trigger the batch jobs.

In some implementations, the QFS 1292 may be an open source file system available from Sun Microsystems® of Santa Clara, Calif. The QFS may serve as a rapid-access file system for storing and accessing information available within the pod 1244. The QFS 1292 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 1268 and/or indexers 1294 to identify, retrieve, move, and/or update data stored in the network file systems 1296 and/or other storage systems.

In some implementations, one or more query servers 1282 may communicate with the NFS 1296 to retrieve and/or update information stored outside of the pod 1244. The NFS 1296 may allow servers located in the pod 1244 to access information to access files over a network in a manner similar to how local storage is accessed.

In some implementations, queries from the query servers 1222 may be transmitted to the NFS 1296 via the load balancer 1228, which may distribute resource requests over various resources available in the on-demand database service environment. The NFS 1296 may also communicate with the QFS 1292 to update the information stored on the NFS 1296 and/or to provide information to the QFS 1292 for use by servers located within the pod 1244.

In some implementations, the pod may include one or more database instances 1290. The database instance 1290 may transmit information to the QFS 1292. When information is transmitted to the QFS, it may be available for use by servers within the pod 1244 without using an additional database call.

In some implementations, database information may be transmitted to the indexer 1294. Indexer 1294 may provide an index of information available in the database 1290 and/or QFS 1292. The index information may be provided to file force servers 1286 and/or the QFS 1292.

As multiple users might be able to change the data of a record, it can be useful for certain users to be notified when a record is updated. Also, even if a user does not have authority to change a record, the user still might want to know when there is an update to the record. For example, a vendor may negotiate a new price with a salesperson of company X, where the salesperson is a user associated with tenant Y. As part of creating a new invoice or for accounting purposes, the salesperson can change the price saved in the database. It may be important for co-workers to know that the price has changed. The salesperson could send an email to certain people, but this is onerous and the salesperson might not email all of the people who need to know or want to know. Accordingly, some implementations of the disclosed techniques can inform others (e.g., co-workers) who want to know about an update to a record automatically.

The tracking and reporting of updates to a record stored in a database system can be facilitated with a multi-tenant database system 16, e.g., by one or more processors configured to receive or retrieve information, process the information, store results, and transmit the results. In other implementations, the tracking and reporting of updates to a record may be implemented at least partially with a single tenant database system.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects.

While the disclosed examples are often described herein with reference to an implementation in which an on-demand database service environment is implemented in a system having an application server providing a front end for an on-demand database service capable of supporting multiple tenants, the present implementations are not limited to multi-tenant databases nor deployment on application servers. Implementations may be practiced using other database architectures, i.e., ORACLE®, DB2® by IBM and the like without departing from the scope of the implementations claimed.

It should be understood that some of the disclosed implementations can be embodied in the form of control logic using hardware and/or using computer software in a modular or integrated manner. Other ways and/or methods are possible using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A computer implemented method for managing objectives associated with an organization, the method comprising:
receiving, at a server, information identifying a first objective, the first objective at a first level of an objective hierarchy identified by objective data stored on a storage medium, the objective data including a first completion indicator, the first completion indicator indicating progress towards completing the first objective;
determining, by the server, a second objective and a third objective, the second objective and the third objective being at a second level of the objective hierarchy, the second level being lower than the first level, the objective data including a second completion indicator indicating progress towards completing the second objective, the objective data including a third completion indicator indicating progress towards completing the second objective, and wherein the progress of the first completion indicator is based on the progress of the second completion indicator and the progress of the third completion indicator; and
providing, to a computing device, at least a portion of the objective data and information identifying the first objective, the second objective, and the third objective.

2. The method of claim 1, the provided objective data including the first completion indicator, the second completion indicator, and the third completion indicator.

3. The method of claim 1, wherein the second objective is associated with a first report, the first report providing a metric associated with a record stored in a database.

4. The method of claim 3, wherein the progress of the second completion indicator is based on the metric, the metric based on data in the record.

5. The method of claim 4, wherein the third objective is associated with a second report, the second report providing a metric associated with the record, wherein the progress of the third completion indicator is based on the metric, the metric based on data in the record.

6. The method of claim 1, wherein the first objective is associated with a first user at a first level of an organizational hierarchy, the second objective is associated with a second user at a second level of the organizational hierarchy, and the third objective is associated with a third user at the second level, the first level being higher than the second level.

7. The method of claim 6, wherein the second objective and the third objective are children of the first objective.

8. The method of claim 7, wherein the second objective is further a child of a fourth objective, the fourth objective being at a higher level of the objective hierarchy than the second level.

9. The method of claim 1, further comprising:
determining the second objective is associated with a number of contributors, the number of contributors being less than a threshold number; and
providing, for the display, an alert associated with the second objective.

10. The method of claim 1, wherein the computing device is one of: a smartphone, a laptop, a tablet, a wearable display device, and a desktop computer.

11. One or more computing devices for using applications, the one or more computing devices comprising:
one or more processors operable to execute one or more instructions to cause a computing device:
receive information identifying a first objective, the first objective at a first level of an objective hierarchy identified by objective data stored on a storage medium, the objective data including a first completion indicator, the first completion indicator indicating progress towards completing the first objective;
determine a second objective and a third objective, the second objective and the third objective being at a second level of the objective hierarchy, the second level being lower than the first level, the objective data including a second completion indicator indicating progress towards completing the second objective, the objective data including a third completion indicator indicating progress towards completing the second objective, and wherein the progress of the first completion indicator is based on the progress of the second completion indicator and the progress of the third completion indicator; and
provide, to a computing device, at least a portion of the objective data and information identifying the first objective, the second objective, and the third objective.

12. The one or more computing devices of claim 11, the provided objective data including the first completion indicator, the second completion indicator, and the third completion indicator.

13. The one or more computing devices of claim 11, wherein the second objective is associated with a first report, the first report providing a metric associated with a record stored in a database.

14. The one or more computing devices of claim 13, wherein the progress of the second completion indicator is based on the metric, the metric based on data in the record.

15. The one or more computing devices of claim 14, wherein the third objective is associated with a second report, the second report providing a metric associated with the record, wherein the progress of the third completion indicator is based on the metric, the metric based on data in the record.

16. The one or more computing devices of claim 11, wherein the first objective is associated with a first user at a first level of an organizational hierarchy, the second objective is associated with a second user at a second level of the organizational hierarchy, and the third objective is associated with a third user at the second level, the first level being higher than the second level.

17. The one or more computing devices of claim 16, wherein the second objective and the third objective are children of the first objective.

18. The one or more computing devices of claim 17, wherein the second objective is further a child of a fourth objective, the fourth objective being at a higher level of the objective hierarchy than the second level.

19. The one or more computing devices of claim 11, the one or more processors further operable to execute one or more instructions to:
determine the second objective is associated with a number of contributors, the number of contributors being less than a threshold number; and
provide, for the display, an alert associated with the second objective.

20. The one or more computing devices of claim 11, wherein the computing device is one of: a smartphone, a laptop, a tablet, a wearable display device, and a desktop computer.

21. A non-transitory computer readable medium having instructions stored thereon, the instructions executable by a processor to cause a computing device to:
receive information identifying a first objective, the first objective at a first level of an objective hierarchy identified by objective data stored on a storage medium, the objective data including a first completion indicator, the first completion indicator indicating progress towards completing the first objective;
determine a second objective and a third objective, the second objective and the third objective being at a second level of the objective hierarchy, the second level being lower than the first level, the objective data including a second completion indicator indicating progress towards completing the second objective, the objective data including a third completion indicator indicating progress towards completing the second objective, and wherein the progress of the first completion indicator is based on the progress of the second completion indicator and the progress of the third completion indicator; and
provide, to a further computing device, at least a portion of the objective data and information identifying the first objective, the second objective, and the third objective.
